(19) United States
(12) Patent Application Publication
(10) Pub. No.: US 2014/0071171 A1
(43) Pub. Date: Mar. 13, 2014

(54) PINCH-AND-ZOOM, ZOOM-AND-PINCH GESTURE CONTROL

(71) Applicants: James W. MCGOWAN, Whitehouse Station, NJ (US); Tom JANISZEWSKI, Andover, NJ (US)

(72) Inventors: James W. MCGOWAN, Whitehouse Station, NJ (US); Tom JANISZEWSKI, Andover, NJ (US)

(73) Assignee: ALCATEL-LUCENT USA INC., Murray Hill, NJ (US)

(21) Appl. No.: 13/611,553

(22) Filed: Sep. 12, 2012

(51) Int. Cl. G06F 3/041; G09G 5/00

(52) U.S. Cl. 345/661; 345/173

(57) ABSTRACT

At least one example embodiment relates to a method comprising: detecting one of a pinch gesture and a zoom gesture as a first event; detecting the other of the pinch gesture and the zoom gesture as a second event; and generating a single event command representing the first and second events if the second event is detected within a desired time period from detecting the first event, the single event command indicating a user-desired function.

### BACKGROUND

Conventional multi-touch display devices have a limited vocabulary of user gestures which are used indicate a user-desired function on a graphical display. Currently supported gestures include the press, long-press, tap, double-tap, swipe, pinch, and zoom gestures. However, the current vocabulary of gestures is not well-suited for indicating some user-desired functions. In particular, gestures indicating cut-and-paste functions or gestures used for inter-application navigation in conventional multi-touch devices rely on complicated menu structures and complex application flow, which results in decreased interface flexibility and introduces latency issues when operating the device.

### SUMMARY

At least some example embodiments provide a method and/or a device for generating a single event command representing a pinch gesture and a zoom gesture.

According to at least one example embodiment, a method comprises: detecting one of a pinch gesture and a zoom gesture as a first event; detecting the other of the pinch gesture and the zoom gesture as a second event; and generating a single event command representing the first and second events if the second event is detected within a desired time period from detecting the first event, the single event command indicating a user-desired function.

According to at least one example embodiment, the single event command is distinct from a command indicating solely the pinch gesture or solely the zoom gesture.

According to at least one example embodiment, the method further comprises: generating a first event command representing only the first event if the second event is not detected within the desired time period from detecting the first event.

According to at least one example embodiment, the generating a first event command generates the first event command if a finality event is detected before the second event and within the desired time period.

According to at least one example embodiment, the desired time period is about 80 ms to about 120 ms.

According to at least one example embodiment, the finality event is a user gesture.

According to at least one example embodiment, the user gesture is a user lifting their fingers from the display.

According to at least one example embodiment, the method further comprises: displaying the user-desired function on a display according to the single event command.

According to at least one other example embodiment, a device comprises: a multi-touch display configured to detect gestures and output event signals indicative of the detected gestures; and a controller configured to generate a single event command if the controller receives first and second event signals within a desired time period of one another, the first event signal indicating one of a pinch gesture and a zoom gesture, the second event signal indicating the other of the pinch gesture and the zoom gesture, the single event command indicating a user-desired function.

According to at least one example embodiment, single event command is distinct from a command indicating solely the pinch gesture or solely the zoom gesture.

According to at least one example embodiment, the controller is configured to generate a first event command in response to only the first event signal if the controller does not receive the second event signal within the desired time period.

According to at least one example embodiment, the controller is configured to generate the first event command if the controller receives a finality event signal before the second event signal and within the desired time period.

According to at least one example embodiment, the desired time period is about 80 ms to about 120 ms.

According to at least one example embodiment, the finality event signal represents a user gesture.

According to at least one example embodiment, the user gesture is a user lifting their fingers from the multi-touch display.

According to at least one example embodiment, the multi-touch display is configured to display the user-desired function according to the single event command.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of example embodiments.

FIG. 1A illustrates a zoom gesture according to at least one example embodiment; FIG. 1B illustrates a pinch gesture according to at least one example embodiment;

FIG. 2 illustrates a multi-touch display device according to at least one example embodiment;

FIG. 3 illustrates a flow diagram of a method of operating a multi-touch display device, such as the multi-touch display from FIG. 2, according to at least one example embodiment; and

FIG. 4 illustrates a flow diagram of a method of operating a multi-touch display device, such as the multi-touch display from FIG. 2, according to at least one other example embodiment.

### DETAILED DESCRIPTION OF EXAMPLE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements (e.g., base stations, base station controllers, NodeBs eNodeBs, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

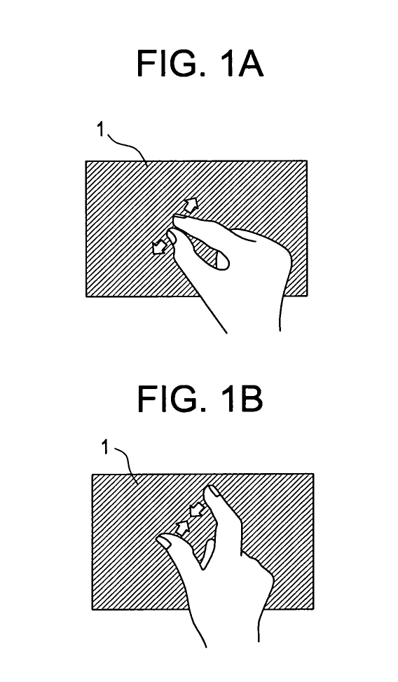

FIGS. 1A and 1B illustrate zoom and pinch gestures for a multi-touch display device according to an example embodiment. FIG. 1A illustrates a zoom gesture, triggered by a user contacting two points on a multi-touch display 1 and then separating those points by some desired distance. A zoom gesture may be used, for example, to indicate a zoom-in function on the display 1. FIG. 1B illustrates a pinch gesture, triggered by the user contacting a multi-touch display 1 at two separated points, and bringing the two contact points together. A pinch gesture may be used, for example, to indicate a zoom-out function on the multi-touch display 1.

Conventional multi-touch display devices detect a pinch gesture and a zoom gesture as two separate events having two different user-desired functions. In other words, conventional multi-touch display devices recognize a user sequentially performing a pinch gesture and then a zoom gesture as two distinct functions no matter how quickly the user performs the gestures (e.g., the display zooms-out and then zooms-in according to sequentially performed pinch and zoom gestures).

A multi-touch display device according to an example embodiment, however, may detect both the pinch and zoom gestures as a single event and generates a single event command representing both gestures. In other words, a user sequentially performs a pinch gesture and a zoom gesture to generate a single pinch-and-zoom event command. Similarly, the user sequentially performs a zoom gesture and a pinch gesture to generate a single zoom-and-pinch event command. The pinch-and-zoom event command and the zoom-and-pinch event command indicate user-desired functions different from the functions of each event considered singly. In other words, the single event command is distinct from a command indicating solely a pinch gesture or solely a zoom gesture.

For example, according to at least one example embodiment, the pinch-and-zoom gesture may serve as a natural gesture for selecting and/or highlighting a region of the display (e.g., a “cut and paste” and/or “copy and paste” function). A user may place their fingers around a section of a desired image and/or text, pinch-and-zoom back to near the original finger positions, and the user interface would highlight the swept over region, and place a copy of the region selected on a clipboard for pasting.

Similarly, according to at least one example embodiment, the zoom-and-pinch gesture may serve as a natural gesture for replacing the conventional “long-press gesture” currently used in multi-touch display devices. The zoom-and-pinch gesture may also be used for page marking. For example, the zoom-pinch gesture may be used to indicate a particular web page as a “favorite.” As another example, the zoom-and-pinch gesture may be used in inter-application navigation and/or intra-application navigation. For example, the zoom-and-pinch gesture may be used to mark a “breadcrumb.” For more information regarding “breadcrumbs,” see U.S. patent application Ser. No. 13/492,318, “SYSTEM AND METHOD FOR MANAGING NETWORK NAVIGATION,” filed Jun. 8, 2012, the entire contents of which are herein incorporated by reference.

In addition to detecting both the pinch and zoom gestures as a single event, a multi-touch display device according to an example embodiment still has the ability to detect each gesture as a single, distinct event (i.e., when a user desires to perform a function according to only one gesture). In this way, a multi-touch display device according to an example embodiment has improved interface flexibility compared to conventional multi-touch devices.

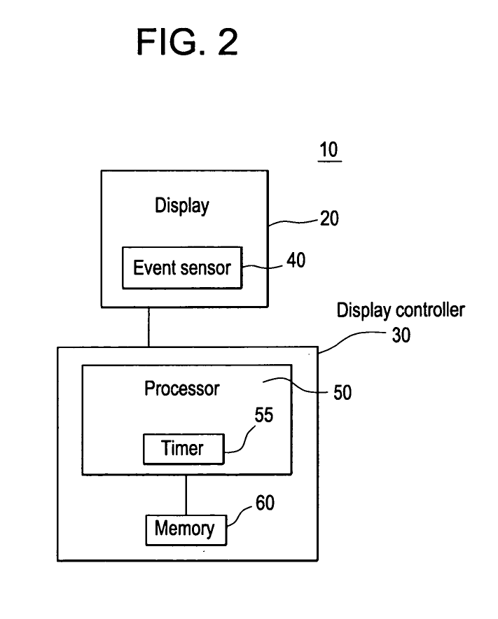

FIG. 2 illustrates a multi-touch display device according to at least one example embodiment.

Referring to FIG. 2, a multi-touch display device 10 (hereinafter, “display device”) includes a display 20 and a display controller 30. The display device 10 may employ a multi-touch technology, such as a multi-touch capacitive technology, a multi-touch resistive technology, a multi-touch optical technology, a multi-touch wave technology, etc. Although not shown, it should be understood that the display device 10 may be managed by an operating system, such as iOS®, Android®, Windows®, etc.

The display controller 30 controls the display 20 and includes a processor 50 and a memory 60. The display controller 30 and the display 20 may be integrated into a single device, such as a mobile phone, smart phone, tablet, personal computer, etc. Alternatively, the display controller 30 and the display 20 may be contained in separate devices. In this case, the display 20 may be a television monitor and the display controller 30 may be contained, for example, in a video game console connected to the television monitor.

The event sensor 40 may include, for example, a charge coupled device (CCD), CMOS image sensor (CIS), and/or any other type of well-known sensor capable of detecting multiple points of contact (e.g., user gestures) on the display 20. It should be understood that event sensor 40 may be an element separate from the display 20 or the event sensor 40 may be part of the display 20. For example, in FIG. 2, the event sensor 40 is part of the display 20. The display 20 and event sensor 40 may operate according to any well-known technology used for gesture detection in multi-touch display devices (e.g., a multi-touch capacitive technology, a multi-touch resistive technology, a multi-touch optical technology, a multi-touch wave technology, etc.). Alternatively, the event sensor 40 may be a motion sensor or any other well-known sensor capable of capturing gestures without contacting the display 20.

According to at least one example embodiment, the display 20 and/or event sensor 40 detect user gestures as events. For example, the event sensor 40 may automatically detect one of a pinch gesture and a zoom gesture as a first event, and automatically detect the other of the pinch gesture and a zoom gesture as a second event.

The display controller 30 may be, for example, a multi-touch display driver or any other well-known device capable of driving a multi-touch display device. According to an example embodiment, the display controller 30 (via the processor 50) selectively generates a single event command representing first and second events. The single event command may be one of a pinch-and-zoom event command and a zoom-and-pinch event command, and may control the display 20 to perform a user-desired function according to the single event command.

Still referring to FIG. 2, the processor 50 may be, for example, an Image Signal Processor (ISP) or other processing device well-known in processing user gestures for multi-touch display devices. According to an example embodiment, the processor 50 receives event signals representing a pinch gesture and a zoom gesture from the event sensor 40, determines whether a desired time period has elapsed between detecting the two gestures, and outputs an event command. For example, the processor 50 may generate a single event command representing the two gestures if the processor 50 determines that the second gesture is detected within the desired time period. In this way, it should be understood that the processor 50 may selectively generate a single event command representing the first and second events.

The processor 50 may include a timer 55. The timer 55 tracks the desired time period and operates in conjunction with the processor 50 to determine whether the desired time period has elapsed between detecting pinch and/or zoom gestures.

The memory 60 may be a computer readable storage medium for storing instructions that control the operation of the processor 50. The memory 60 may also store data associated with event commands generated by the processor 50. For example, in the case of a zoom-and-pinch event command that indicates a “breadcrumb,” the memory 60 may store the location of the breadcrumb.

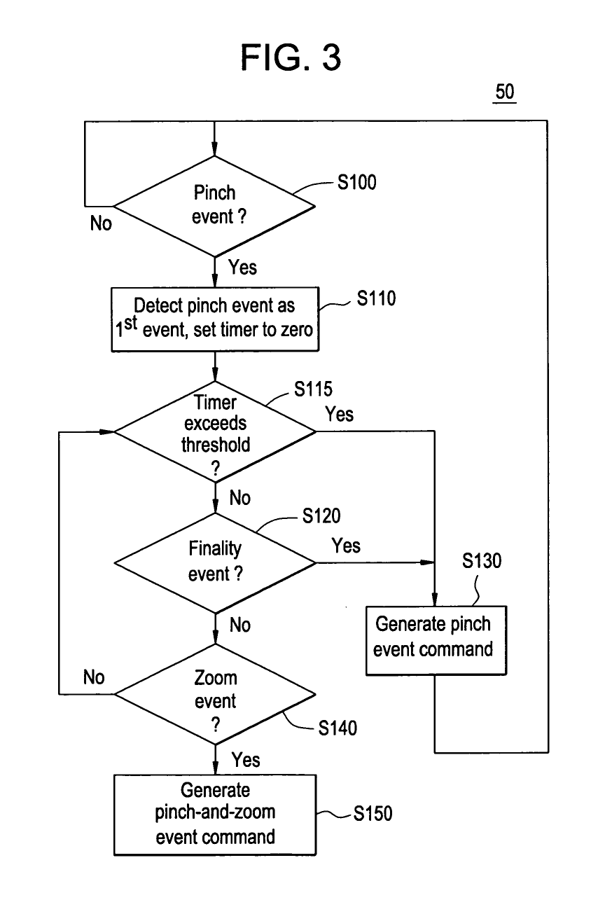

FIG. 3 illustrates a flow diagram of a method of operating the display device 10 from FIG. 1, according to at least one example embodiment.

Referring to FIGS. 2 and 3, the processor 50 receives, at least, a signal from the display 20 and/or event sensor 40 indicating the zoom gesture of FIG. 1A, the pinch gesture of FIG. 1B, or a finality gesture. It should also be understood that the processor 50 may receive and process other user gestures typically associated with multi-touch display devices, such as press, long-press, tap, double-tap, swipe, etc. The processor 50 may regard each user gesture as an event. In step S100 of FIG. 3, the processor 50 determines whether a received signal is a signal indicating that a user performed a pinch event on the display 20. If the processor 50 determines a pinch event has been performed, then according to step S110, the processor 50 identifies the signal indicating the pinch event as a first event and sets the timer 55 to zero. If the processor 50 does not determine that a pinch event is detected, then the processor continues to check for pinch events.

According to step S115, the processor 50 determines whether the timer 55 has exceeded a desired threshold time period since receiving the pinch event. Referring to steps S115, S120, and S130, the processor 50 generates a pinch event command (S130) if: 1) the timer exceeds the desired threshold time period before the processor 50 receives a signal indicating a zoom event (S115); or 2) the processor 50 receives a signal indicating a finality event within the desired threshold time period and before receiving a zoom event (S120). Although not shown, the display device 10 then performs a user-desired function (e.g., a zoom-out function) according to only the pinch event command generated in step S130.

In at least one example embodiment, a finality event is a user-based event defined by, for example, a user lifting their fingers from the display 20, or by performing some other gesture the display device 10 recognizes as a gesture that indicates a user would like to perform a function according to only the pinch gesture.

According to steps S140 and S150, the processor 50 generates a pinch-and-zoom event as a single event command if: 1) the processor 50 receives a signal indicating a zoom event as a second event before the timer 55 exceeds the desired time threshold; and 2) the processor 50 does not receive the signal indicating the finality event before receiving the signal indicating the zoom event. The pinch-and-zoom event command generated in step S150 is a single event command representing both the pinch and zoom gestures. Although not shown, the pinch-and-zoom event command generated in step S150 causes the display device 10 to perform a user-desired function, such as a cut-and-paste function. In other words, according to an example embodiment, the single event command is distinct from a command indicating solely a pinch gesture or solely a zoom gesture.

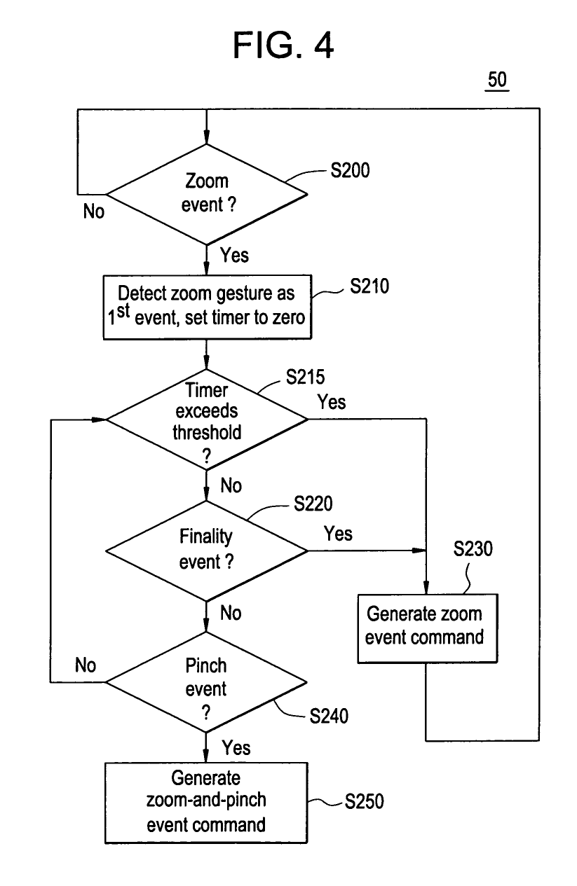

FIG. 4 illustrates a flow diagram of a method of operating the display device 10 from FIG. 1, according to at least one example embodiment. FIG. 4 is similar to FIG. 3 except that in FIG. 4, the processor 50 receives a zoom gesture as the first event and a pinch gesture as a second event.

Referring to FIGS. 2 and 4, the processor 50 receives, at least, a signal from the display 20 and/or the event sensor 40 indicating the zoom gesture of FIG. 1A, the pinch gesture of FIG. 1B, or a finality gesture. It should also be understood that the processor 50 may receive and process other user gestures typically associated with multi-touch display devices, such as press, long-press, tap, double-tap, swipe, etc. The processor 50 may regard each user gesture as an event. In step S200 of FIG. 4, the processor 50 receives a signal and determines whether the signal indicates a user performed a zoom event on the display 20. If the processor 50 determines that a zoom event was performed, according to step S210, the processor 50 identifies the signal indicating the zoom event as a first event and sets the timer 55 to zero. If the processor 50 does not determine that a zoom event was performed, then the processor 50 continues to check for zoom events.

According to step S215, the processor 50 determines whether the timer 55 has exceeded a desired threshold time period since receiving the zoom event. Referring to steps S215, S220, and S230, the processor 50 generates a zoom event command (S230) if: 1) the timer exceeds the desired threshold time period before the processor 50 receives a signal indicating a pinch event (S215); or 2) the processor 50 receives a signal indicating the user has performed a finality event within the desired threshold time period and before receiving a pinch event (S220). Although not shown, the display device 10 then performs a user-desired function (e.g., a zoom-in function) according to only the zoom event command generated in step S130. In at least one example embodiment, a finality event is a user-based event defined by, for example, a user lifting their fingers from the display 20, or by performing some other gesture the display device 10 recognizes as a gesture that indicates a user would like to perform a function according to only the zoom gesture.

According to steps S240 and S250, the processor 50 generates a zoom-and-pinch event as a single event command if: 1) the processor 50 receives a signal indicating a pinch event as a second event before the timer 55 exceeds the desired time threshold; and 2) the processor 50 does not receive the signal indicating the finality event before receiving the signal indicating the pinch event. The zoom-and-pinch event command generated in step S250 is a single event command representing both the zoom and pinch gestures. Although not shown, the zoom-and-pinch event command generated in step S250 causes the display device 10 to perform a user-desired function, such as an inter-application navigation function. In other words, according to an example embodiment, the single event command is distinct from a command indicating solely a pinch gesture or solely a zoom gesture.

According to at least one example embodiment, the desired time threshold in FIGS. 3 and 4 is between about 80 ms to about 120 ms. However, example embodiments are not limited thereto. The desired time threshold may be adjusted according to desired performance characteristics of a multi-touch display device. Still, it should be understood that time thresholds longer than 120 ms may decrease the responsiveness of the display device 10. Further, time thresholds shorter than 80 ms may result in inaccurate identification of events (e.g., identifying a pinch-and-zoom event as only a pinch event). Although FIGS. 3 and 4 show the timer 55 counting up to the desired time threshold from zero, it should be understood that the timer 55 may count down from the desired time threshold to zero.

Referring to FIGS. 2-4, it should be understood that the flow diagrams of FIGS. 3 and 4 may be combined and expressed as a set of computer readable instructions stored on the memory 60 and executed by the processor 50 to control the display 20. It should be also understood that the steps in FIGS. 3 and 4 may be continuously and/or simultaneously performed by the processor 50 during the operation of the display device 10. Further, it should be understood that each of the steps in FIGS. 3 and 4 may indicate the transmission of electronic signals to and from processor 50 and/or display 20. For example, the display 20 and/or event sensor 40 may convert each gesture into an electronic signal (e.g., an event signal) and transmit the electronic signal to the processor 50. Similarly, the processor 50 may receive event signals from the display 20 and generate an appropriate event command as an electronic signal and transmit the event command to the display 20.

Variations of the example embodiments are not to be regarded as a departure from the spirit and scope of the example embodiments. For example, although the above description relates to detecting finger gestures on a multi-touch display, it should be understood that example embodiments are not limited thereto. In at least one example embodiments, the gestures may be detected in a tactile response system using a fitted glove that tracks finger position. As another example, the gestures may be detected by a camera or motion sensor capturing gestures for a motion based video game on a video game console. In at least one example embodiment, the gestures may be performed with multiple fingers, multiple hands, full arms, etc.

Further, it should be understood that example embodiments are not limited to the above described user-desired functions for a pinch-and-zoom event command or a zoom-and-pinch event command. It should be understood that other user-desired functions could be performed according to either of the pinch-and-zoom or zoom-and-pinch commands. All such variations as would be apparent to one skilled in the art are intended to be included within the scope of this disclosure.

What is claimed is:

1. A method, comprising:
detecting one of a pinch gesture and a zoom gesture as a first event;
detecting the other of the pinch gesture and the zoom gesture as a second event; and
generating a single event command representing the first and second events if the second event is detected within a desired time period from detecting the first event, the single event command indicating a user-desired function.

2. The method of claim 1, wherein the single event command is distinct from a command indicating solely the pinch gesture or solely the zoom gesture.

3. The method of claim 2, further comprising:
generating a first event command representing only the first event if the second event is not detected within the desired time period from detecting the first event.

4. The method of claim 3, wherein the generating a first event command generates the first event command if a finality event is detected before the second event and within the desired time period.

5. The method of claim 4, wherein the desired time period is about 80 ms to about 120 ms.

6. The method of claim 4, wherein the finality event is a user gesture.

7. The method of claim 6, wherein the user gesture is a user lifting their fingers from the display.

8. The method of claim 1, further comprising:
displaying the user-desired function on a display according to the single event command.

9. The method of claim 1, wherein the desired time period is about 80 ms to about 120 ms.

10. A device, comprising:
a multi-touch display configured to detect gestures and output event signals indicative of the detected gestures; and
a controller configured to generate a single event command if the controller receives first and second event signals within a desired time period of one another, the first event signal indicating one of a pinch gesture and a zoom gesture, the second event signal indicating the other of the pinch gesture and the zoom gesture, the single event command indicating a user-desired function.

11. The device of claim 10, wherein single event command is distinct from a command indicating solely the pinch gesture or solely the zoom gesture.

12. The method of claim 10, wherein the controller is configured to generate a first event command in response to only the first event signal if the controller does not receive the second event signal within the desired time period.

13. The device of claim 12, wherein the controller is configured to generate the first event command if the controller receives a finality event signal before the second event signal and within the desired time period.

14. The device of claim 13, wherein the desired time period is about 80 ms to about 120 ms.

15. The device of claim 13, wherein the finality event signal represents a user gesture.

16. The device of claim 15, wherein the user gesture is a user lifting their fingers from the multi-touch display.

17. The device of claim 10, wherein the desired time period is about 80 ms to about 120 ms.

18. The device of claim 10, wherein the multi-touch display is configured to display the user-desired function according to the single event command.
